(19) United States
(12) Patent Application Publication
(10) Pub. No.: US 2007/0219932 A1
(43) Pub. Date: Sep. 20, 2007

(54) Cooperative energy farms and virtual net metering

(76) Inventors: Scott T. Carroll, Lakeside, CA (US); Kenneth E. Wing, Alpine, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/717,924

(22) Filed: Mar. 14, 2007

Related U.S. Application Data
(60) Provisional application No. 60/782,527, filed on Mar. 15, 2006.

(51) Int. Cl. G01R 21/133

(52) U.S. Cl. 705/412

(57) ABSTRACT

The present invention is directed to a method of providing current energy consumers with a method by which they are able to pay for renewable energy from Cooperative Energy Farms and Virtual Net Metering. Power Output Data is sent to the Ratepayer via Internet. Power Out-put Data is sent to the Utility Company from the Cooperative Energy Farms. This system provides the average power consumer to invest in renewable energy without the prohibitive expense and without having to move their residences to windy or south facing hills for wind turbines or solar energy grids. The privately owned energy generation plots (Cooperative Energy Farm) provides a continuous source of energy sent in to the pre-existing energy grid. This energy would be paid for by largely urban rate payers and would act to provide renewable energy sources without the expense and destructive results of fossil fuel usage.

This patent application claims the benefit of U.S. provisional patent application Ser. No. 60/782,527 filed on Mar. 15, 2006.

### FIELD OF THE INVENTION

The present invention is directed to enable a larger segment of the population that buys electrical power from a utility company to participate in renewable energy generation and economic savings. More particularly, the present invention provides current energy consumers with a method by which they are able to pay for renewable energy through cooperative energy farms and virtual net metering.

### BACKGROUND OF THE INVENTION

The need for renewable energy sources in the United States is monumental and is growing more acute.

The demand for electric energy is monumental and growing. Generating costs are increasing dramatically, due in large part to the sharp increases in the cost of the raw material, fossil fuels. Fossil fuels are in decreasing supply. Worldwide demand is outstripping the ability of energy companies to discover and bring in new sources. A myriad of environmental concerns force rightful restrictions on the discovery and bring in new sources. A myriad of environmental concerns force rightful restrictions on the discovery, production, and refining of more fossil fuels. Reserves are dwindling. More reserves are certainly available, but are the recovery of the last bit available worth the irreparable damage to our earthly home?

Enter renewable energy. Many forms are currently being developed. One of the most notable achievements of the semiconductor age is the solar cell. The solar cell makes use of a renewable resource that is free and plentiful. Made from the most plentiful element on earth, silicon, the solar cell converts sun energy to electric energy through what is commonly known as the photovoltaic (PV) effect. When assembled into panels of multiple cells and the panels are exposed to the southern sky, they generate useful power levels at convenient voltages. Studies have shown that as little as 100 square miles of solar panels in the Nevada desert would generate enough electricity to power the entire demand of the United States.

Dependable, renewable sources of power are currently available, however, the location of many power consumers prohibits their installation and exploitation. The large wind powered generators require very large towers and location in a place where winds are constant. Solar cells require south facing slopes and relatively large surface areas in order to be effective. Very few urban settings are amenable to such equipment. In turn, many of the areas that would support such technology are not viable for urban housing developments. In addition, investments in technology which would service the average power consumer may be prohibitive to the average consumer. The solution to make technology available to large numbers of urban consumers would be cooperative wind turbine or solar energy “farms”. These farms would produce energy from renewable sources, send this energy into the current power grids and provide the urban consumer with credits toward their energy bills.

Another useful form of renewable energy generation is by capturing the energy of the wind. Areas with significant and regular wind lend themselves to the use of wind powered generators. An advantage of wind energy is the continuous nature of it; there may be as much wind in dark hours as during the light.

The state of California is a vanguard in the promotion of electricity generated by renewable energy (RE) sources, like PV panels and wind generators. PV panels and related equipment are being produced by a relatively new and fledgling industry, with a significant base of these companies located in California. At the current state of the art, Wind or PV electric generation costs are not quite on parity with utility generated power; the cost per watt is somewhat higher. To make the technology attractive to the ratepayer, the California State Energy Commission, and now the California Public Utility Commission, has “stepped up to the plate” to help equalize the costs of renewable power generation through subsidies for qualified installations. This landmark legislation and rulemaking, in concert and cooperation with California's electricity producing utility companies, is causing a wave of interest in local self owned power generation. Using these subsidies, and working with a licensed contractor or self-installing, the ratepayer can install a grid-tied RE system at their home or business address at a cost competitive over time with utility produced power.

The alternative energy technology available to ratepayers is typically grid-tied RE system. The solar or wind system is directly connected to the local power grid through a power meter that records power in both directions. “Net Metering” is the process used to account for the power generated vs. power used. The local power meter is read and the readings recorded on a normal monthly basis, but no bill is produced. At the end of the 12 month period, if the system has produced more power than was consumed, no billing is generated, and in many instances, no credit for excess power generated is available to the ratepayer. If more power is used than was produced for the period, the ratepayer is presented with a bill for the difference.

A limiting factor of the state's program is that the qualified RE system must be located at the ratepayer's billing address. But there are many practical factors that may prevent the ratepayer from being able to install one. Simple geographic location is one. The property may be in an area that does not receive adequate sun or wind exposure, like on a slope or valley, or it may have trees or other objects that provide shading or blockage, dramatically decreasing the amount of natural energy exposure. An impediment to PV systems may be that the property is located in a region where there is significant weather related solar blockage, as with some coastal or other regularly cloudy or foggy areas. Local Building codes or other property restrictions or covenants may also play in the prevention of the ratepayer's being able to construct an adequately sized or powerful RE system.

The invention provides a system wherein a remote location is set aside and maintained for the express purpose of facilitating ratepayer owned or leased renewable energy generation. Ratepayer owned solar P.V. systems, for example, will deliver electric power to a shared power grid through a shared infrastructure. The shared infrastructure for example may include grid tie inverters, electric distribution cables, remote monitoring and reporting instruments. The ratepayers will be credited for new kilowatt hours delivered to the power grid. The kilowatt hour credits (in whole or portion) are used to off-set the ratepayer's electric energy usage. This portion of the system is known to those skilled in the art as “Net Metering”. The ratepayers will own or lease an undivided portion of the system, (real property, equipment and improvements) as tenants-in-common (or other legally appropriate fractional ownership).

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

A primary object of the invention is to allow all ratepayers an equal opportunity to participate in federal, state and local renewable energy programs (i.e. state, federal, and local rebates, tax credits, and the like).

Another objective of the invention is to stimulate and expand the use of renewable energy sources by ratepayers. A specific program now in place in California, for example, is the Million Solar Roofs program, recently funded by the California Public Utilities Commission.

Another objective of the invention is to assist federal, state and local governments in achieving their renewable energy goals.

Another objective of the invention is to provide energy production that is in excess of the consumption of the ratepayer, into the shared power grid thereby reducing the total energy demand for fossil and other non-renewable sources of energy.

It must be clearly understood at this time although the preferred embodiment of the invention consists of the renewable energy from wind powered turbines and photovoltaic cells, that many other mechanical devices exist, including ocean tide and water powered turbines, or combinations thereof, that will achieve the a similar operation and they will also be fully covered within the scope of this patent.

Other objectives and advantages of the invention will become apparent from the following description and drawings wherein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a general schematic of one implementation of the invention. Widely dispensed individual ratepayers draw electricity from a shared power grid. Each of the depicted ratepayers purchases a portion of a Cooperative Energy Farm, (CEF) 70. Ratepayers then contract to have solar photovoltaic (PV) panels installed on their portion of the CEF 70, or purchase and existing populated plot. The individual solar PV panels are connected to central and shared grid-tie inverters (a portion of which can be owned by the ratepayer). The grid-tie inverters are compliant with Advanced Metering Infrastructure (AMI), and as such are remotely monitored and controlled by the utility companies operating the shared power grid to which they are connected. A report of energy generated from the ratepayer's portion of the CEF is transmitted to the electric utility company. Performance and surveillance data are also transmitted to the operating Energy Maintenance Company (EMC) 70 responsible for the CEF.

FIG. 2 is a flow chart delineating the prior art aspects of Net Metering. Current art provides for Net Metering as outlined in the left hand flow chart labeled “Net Metering.” The ratepayers' meter is either of a type that will run backwards or the ratepayer has two meters, one showing total energy consumed and the other showing total energy produced. The meter reader records this data manually, a calculation is made to determine the net energy usage and that data is stored for use in monthly or annual billing.

FIG. 3 depicts a flow diagram illustrating the elements of Virtual Net Metering or VMN. A novel business method of the invention is VNM 10. The present invention implements VNM. Meter readers will still read the ratepayers' meter at the ratepayer's location as usual. The utility company will also electronically request energy production records for the same period from the ratepayer's virtual meter at the CEF 70. The flow from this point is identical to standard Net Metering in that the net energy usage is calculated, stored and used for the annual Net Metering energy billing.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

For a fuller understanding of the nature and objects of the invention, reference should be had to the following detailed description taken in conjunction with the accompanying drawings wherein similar parts of the invention are identified by like reference numerals.

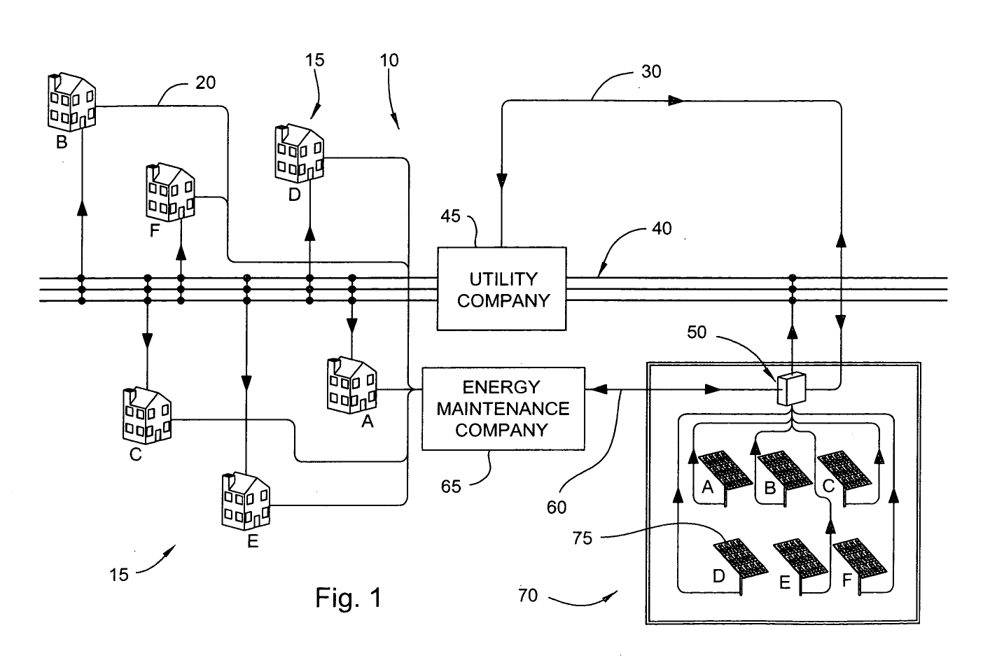

Referring now to FIG. 1, there is seen in a schematic of one embodiment of the present invention illustrating the relationship between the component parts of the cooperative energy farm (CEF) and virtual net metering (VNM) system 10. Widely dispersed individual ratepayers 15, individually denoted as A, B, C, D, E and F, draw electricity from a shared power grid 40. These ratepayers 15 may include residential or business renters, condominium owners, apartment dwellers or other home and/or business owners who do not have the option of installing renewable energy generation equipment “on-site” at their particular location.

Each of the depicted ratepayers purchases or leases a portion of a CEF 70, known as “fractional ownerships.” Title to said “fractional ownership” portions of the CEF 70 may be held as Tenants-In-Common (or other legally appropriate form of title) of a specified factional portion of the CEF 70. Access to the CEF 70 by the individual owners will be restricted to escorted appointed visits as specified in a separate covenant. Ratepayers 15 then contract with a qualified energy contractor to have solar PV panels 75 for example, installed on their owned portion of the CEF 70 and connected to the common infrastructure within the CEF 70. These fractionally owned installed solar panels 75 are depicted as A, B, C, D, E and F, and are owned by ratepayers 15 A, B, C, D, E and F, respectively.

In another embodiment of the invention, the ratepayer would purchase or lease a portion of the CEF 70 with renewable energy generation devices pre-installed. The individual solar PV panels in this example are all connected to central grid-tie inverters 50. The grid-tie inverters 50 are Advanced Metering Infrastructure (AMI) compliant, and as such are remotely monitored and controlled by the utility companies 45 operating the shared power grid 40 to which they are connected.

In one embodiment of the invention, the communications carried out between the utility company and the CEF 70 and between the Energy Maintenance Company (EMC) 65 and the CEF 70 are by means of satellite Internet connections, or some other wireless means of communications. This means of communications makes the invention practical for extremely remote locations of the CEF 70.

In other embodiments of the invention, communications may be made via existing telephone systems. Energy production information 30 is transmitted to the utility company 45 and used to determine the ratepayers' 15 net monthly power usage. Instantaneous performance data and physical CEF 70 security surveillance data 60 are transmitted to the EMC 65 charged with security and maintenance responsibility for the CEF 70. Ratepayer CEF 70 owners may, via password protected internet access 20 to the EMC's web site, view their historical energy production and in real time as well as view a CEF security “web cam.”

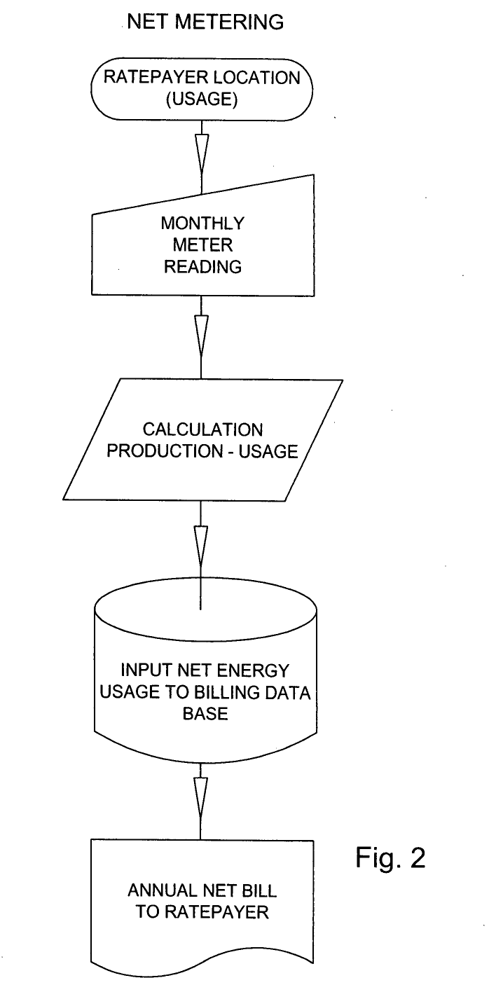

Referring now to FIG. 2 this flow diagram delineates the prior art Net Metering process. Net Metering is an essential portion of renewable energy co-production, and as such, has been around for many years.

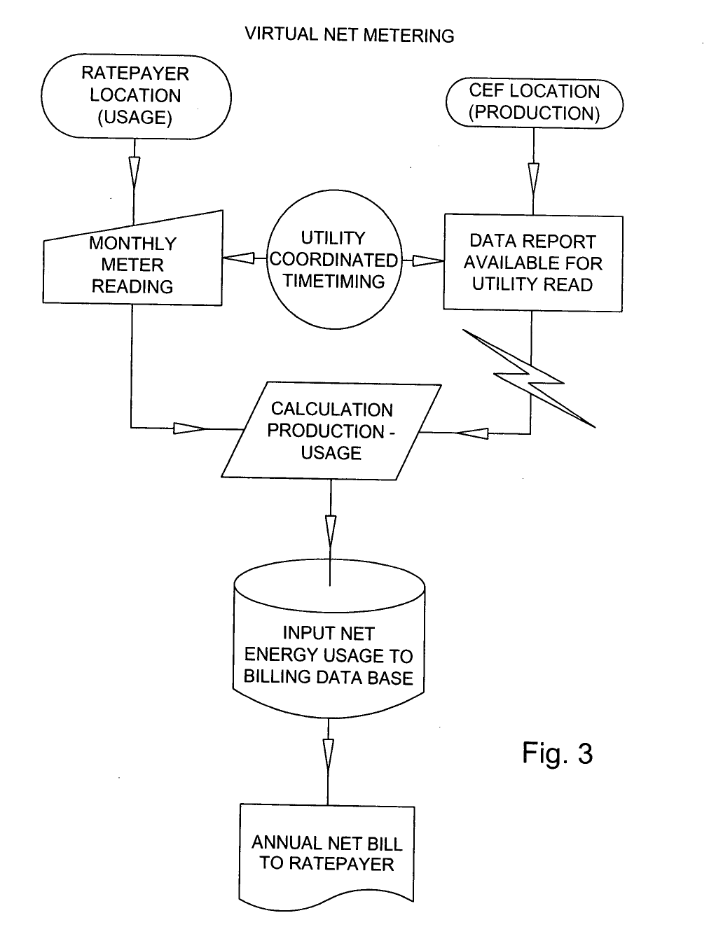

Referring now to FIG. 3, there is shown a flow diagram illustrating the Virtual Net Metering system of the present invention. The present invention takes Net Metering one step further, to generate Virtual Net Metering, by remote polling of the energy production data of individual ratepayers by the utility company, at will. Although great distances may separate the ratepayer from his or her CEF plot, the distance is virtually transparent to the utility company. The metrology for the CEF 70 may be modified, certified and inspected as required by the utility company to which this bi-directional communications system is connected.

There are many advantages of the invention for the utility companies. Among them are renewable energy generation devices that are all professionally installed and maintained providing safer and consistent installations. The devices installed in any one CEF 70 will all be similar in type and installation such that in the event utility personnel need to enter the facility confusion will be limited. In the event of an emergency, the CEF 70 may be disconnected and isolated from the shared power grid 40 instantly via remote control from either the utility company 45 or the EMC 65. Anti-Islanding protection to prevent back-feeding inverter generated power to the grid in the event of a utility power outage or planned maintenance may be part of the infrastructure.

There are many advantages of the invention to the ratepayer/owner. Among them are: The ability to participate in local, state and national renewable energy programs regardless of the geographic location or dwelling type. Another advantage is increased energy conversion efficiency; by participating in a CEF 70, ratepayer's solar PV systems may be located in an area that may produce substantially more energy per unit area than would be possible at the location of the ratepayer's site meter.

There are many advantages of the invention to the government. Among them are: Increased participation in renewable energy generation, helping to meet state and national renewable energy goals. Increased production in the renewable energy manufacturing sectors will create jobs and tax revenues. Another benefit is a reduction of pollutant emissions from standard fossil fuel consuming power generation plants.

One novel business method of the invention is that it allows all ratepayers the opportunity to participate in renewable energy generation independent of physical location of the ratepayer's electric meter.

In other embodiments of the invention, the plots and/or equipment in the CEF 70 are leased to the ratepayer 15 instead of owned. This would be accomplished through an accredited leasing company, through a long term lease, so as to the CEF 70, the net business effect appears the same as if the ratepayer 15 purchased the plot.

In other embodiments of the invention, the CEF 70 is fully populated with renewable energy producing devices prior to the sale or lease to individual ratepayers. As sales are made, title to individual plots are transferred. The energy produced by the remaining un-sold plots will be sold to the local utility company 45 by the EMC 65 until such time that the plot is sold.

The Cooperative Energy Farms and Virtual Net Metering system 10 shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a Cooperative Energy Farms and Virtual Net Metering system 10 in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A cooperative energy farm and virtual net metering system comprising:
a) one or more privately owned energy generation plots forming cooperative energy farms;
b) an array of two or more renewable energy system devices located on said generation plots, and a grid tie inverter, whereby said array of renewable energy system devices generate energy and feed it to said grid tie inverter;
c) a utility company energy transmission system which receives energy from said grid tied inverter and distributes that energy to its individual ratepayer customer's sites; and
d) an energy maintenance company that measures and monitors performance and security surveillance data from said cooperative energy farm, and through a global computer network, transmits power output data from said cooperative energy farm to said ratepayer customers;
whereby those utility customers not capable of operating a renewable energy source can participate in the economic savings related to the generation of energy via renewable energy system devices.

2. The cooperative energy farm and virtual net metering system according to claim 1, wherein said one or more privately owned energy generation plots forming cooperative energy farms includes privately owned energy generation plots located in remote areas optimal for the generation of renewable energy.

3. The cooperative energy farm and virtual net metering system, according to claim 1, wherein said array of two or more renewable energy system devices located on said generation plots includes solar energy generation technology devices, such as solar photovoltaic panels.

4. The cooperative energy farm and virtual net metering system according to claim 1, wherein said array of two or more renewable energy system devices located on said generation plots includes wind energy generation technology devices, such as wind turbines.

5. The cooperative energy farm and virtual net metering system according to claim 1, wherein said renewable energy system devices are fractionally owned by said individual ratepayer customers.

6. The cooperative energy farm and virtual net metering system according to claim 5, wherein said individual ratepayer customers that own or lease said renewable system devices located at said cooperative energy farms, are capable of monitoring energy production at said cooperative energy farms via a global computer network.

7. The cooperative energy farm and virtual net metering system according to claim 1, wherein said individual ratepayer customers that own or lease said renewable system devices located at said cooperative energy farms, receive a proportional reduction in energy costs related to the generation of renewable energy based upon their fractional ownership of said renewable energy system devices located at said cooperative energy farms.

8. The cooperative energy farm and virtual net metering system according to claim 1, wherein said system enables said utility company to generate virtual net metering by remote polling of the energy production data of individual ratepayers, at will, in real time.

9. The cooperative energy farm and virtual net metering system according to claim 1, wherein said energy maintenance company receives energy generation data from said grid-tie inverters and makes said data available to said ratepayer customers via a global computer network.

10. The cooperative energy farm and virtual net metering system according to claim 9, wherein said energy generation data is available to said ratepayer customers on a real time basis via an Internet connection.

11. A method for enabling energy consumers not capable of operating a renewable energy source to participate in the economic savings related to the generation of energy via renewable energy system devices, comprising the steps of:
a) providing one or more privately owned energy generation plots forming cooperative energy farms;
b) installing an array of two or more renewable energy system devices located on said generation plots, and a grid tie inverter, whereby said array of renewable energy system devices generate energy and feed it to said grid tie inverter;
c) connecting a utility company energy transmission system which receives energy from said grid tied inverter and distributes that energy to its individual ratepayer customers sites; and
d) providing an energy maintenance company that measures and monitors performance and security surveillance data from said cooperative energy farm, and through a global computer network, transmits power output data from said cooperative energy farm to said ratepayer customers;
whereby those utility customers not capable of operating a renewable energy source can participate in the economic savings related to the generation of energy via renewable energy system devices.

12. The method for enabling energy consumers not capable of operating a renewable energy source to participate in the economic savings related to the generation of energy via renewable energy system devices, according to claim 11, wherein said step of providing said one or more privately owned energy generation plots forming cooperative energy farms, includes the step of providing privately owned energy generation plots located in remote areas optimal for the generation of renewable energy.

13. The method for enabling energy consumers not capable of operating a renewable energy source to participate in the economic savings related to the generation of energy via renewable energy system devices, according to claim 11, wherein said step of installing an array of two or more renewable energy system devices located on said generation plots, includes the step of installing solar energy generation technology devices, such as solar photovoltaic panels.

14. The method for enabling energy consumers not capable of operating a renewable energy source to participate in the economic savings related to the generation of energy via renewable energy system devices, according to claim 11, wherein said step of installing an array of two or more renewable energy system devices located on said generation plots, includes the step of installing wind energy generation technology devices, such as wind turbines.

15. The method for enabling energy consumers not capable of operating a renewable energy source to participate in the economic savings related to the generation of energy via renewable energy system devices, according to claim 11, wherein said step of installing said renewable energy system devices includes the step of installing renewable energy system devices which are fractionally owned by said individual ratepayer customers.

16. The method for enabling energy consumers not capable of operating a renewable energy source to participate in the economic savings related to the generation of energy via renewable energy system devices, according to claim 15, wherein said step of installing renewable energy system devices which are fractionally owned by said individual ratepayer customers further includes the step wherein said individual ratepayer customers that own or lease said renewable system devices located at said cooperative energy farms, are capable of monitoring energy production at said cooperative energy farms via a global computer network.

17. The method for enabling energy consumers not capable of operating a renewable energy source to participate in the economic savings related to the generation of energy via renewable energy system devices, according to claim 11, wherein said individual ratepayer customers that own or lease said renewable system devices located at said cooperative energy farms, receive a proportional reduction in energy costs related to the generation of renewable energy based upon their fractional ownership of said renewable energy system devices located at said cooperative energy farms.

18. The method for enabling energy consumers not capable of operating a renewable energy source to participate in the economic savings related to the generation of energy via renewable energy system devices, according to claim 11, wherein said system enables said utility company to generate virtual net metering by remote polling of the energy production data of individual ratepayers, at will, in real time.

19. The method for enabling energy consumers not capable of operating a renewable energy source to participate in the economic savings related to the generation of energy via renewable energy system devices, according to claim 11, wherein said energy maintenance company receives energy generation data from said grid-tie inverters and makes said data available to said ratepayer customers via a global computer network.

20. The method for enabling energy consumers not capable of operating a renewable energy source to participate in the economic savings related to the generation of energy via renewable energy system devices, according to claim 19, wherein said energy generation data is available to said ratepayer customers on a real time basis via an Internet connection.
